(19) United States
(12) Patent Application Publication
(10) Pub. No.: US 2014/0088859 A1
(43) Pub. Date: Mar. 27, 2014

(54) PROCESS AND DEVICE TO TRACK CONTAINERS BEING MOVED IN A HARBOR TERMINAL WITH THE ASSISTANCE OF A TRACTOR

(71) Applicant: IDENTEC SOLUTIONS AG, Lustenau (AT)

(72) Inventor: Dieter Bachmann, Feldkirch (AT)

(21) Appl. No.: 14/019,835

(22) Filed: Sep. 6, 2013

(30) Foreign Application Priority Data
Sep. 25, 2012 (DE) 10 2012 018 850.1

(51) Int. Cl. B65G 63/00

(52) U.S. Cl. CPC B65G 63/004
USPC 701/300

(57) ABSTRACT

A process to track at least one container (1a, 1b), which is loaded at the unloading area of harbor terminal (2) by container crane (5a) located there onto at least one trailer (8a, 8b) of vehicle (3), which is moved to placement position (6), and which is unloaded there by a second container crane (5b) to storage position (15), where the position of the loaded or unloaded container (1a, 1b) on one of the trailers (8a, 8b, 9a, 9b) of vehicle (3) is determined by a measurement of the distance (13, 13a, 13b) between vehicle (3) and container crane (5a, 5b).

The invention concerns a process and a device to track containers. The container is loaded here in a container terminal from a ship moored at a quay by means of a container crane located there onto a vehicle, moved by means of a tractor to a storage yard, and deposited there onto a storage plot by an associated crane.

When containers are off-loaded in a harbor terminal, there is the problem that the container being offloaded from the ship by means of a land-based crane is to be placed onto a storage site. The container being moved by the container crane will be deposited onto a tractor-propelled trailer, where the problem is that one or more containers may be placed on the trailers attached to the tractor. For a combination of 20 and 40 foot containers, a trailer platform may be loaded with a single 40 foot container or two 20 foot containers. Thus, there is no certainty what number and what types of containers may be loaded onto the trailers behind a particular tractor.

For simplicity, the following description will refer to trailers behind a tractor, because such tractor-trailer vehicles in container terminals will normally consist of a tractor with one or more trailers.

Of course, the simplest case refers to a tractor with a single trailer, where this trailer may be linked to a second trailer in order to extend the length and loading capacity of the unit.

In the past, the linkage between container and tractor-trailer vehicle was monitored either manually or by camera-based systems. The use of cameras in inclement situations and in various weather patterns yielded limits to the reliability of the system. An automatic linkage between a container and the loaded position that does not rely on cameras had not been possible in the past.

Thus, the invention has the objective of determining the loaded position of containers on at least one trailer platform of a tractor-trailer vehicle automatically and without the use of camera systems.

The objective is solved by the technical content of claim 1.

The essential characteristic of the invention is the determination of the distance between the tractor of the tractor-trailer vehicle and the lift of the crane in the direction of the longitudinal axis of the tractor-trailer vehicle.

It is thus possible to make an unambiguous determination at what point on the one or more trailers the lift of the container cranes has deposited the just processed container.

Consequently, a process is described to track at least one container that is offloaded at the quay of a harbor terminal by a container crane situated there onto at least one trailer of a tractor-trailer vehicle, moved to a storage yard and deposited there onto a storage plot by an additional container crane.

The position of the container being offloaded or loaded onto a trailer of the tractor is determined by a determination of the distance between the tractor and the container crane.

That will lead to an unambiguous determination whether the container moved by the lift of the container crane has been deposited on the forward or rear trailer platform. Likewise, in the case of a single trailer platform, it is feasible to determine the position on said trailer platform.

The distance can be determined either directly by a distance measurement or indirectly by the determination of the position of the crane and of the tractor.

A specific embodiment uses a Real Time Location System (RTLS) to determine the distance, which provides an additional benefit, namely that the vehicle identification (vehicle ID) may be linked to the determination of the distance. If the determination of the distance is not handled by RTLS, another suitable technology (such as RFID, OCR) may be used to identify the vehicle.

It is essential to the invention that the measurement of the distance is done at the time when the container is being put into place.

The container ID will be provided to the system by the crane control or another harbor system.

The secured data (container ID, vehicle ID, distance) are unambiguous in describing the loaded position of a container on the tractor-trailer vehicle. This is accomplished by determining the distance between the tractor of the tractor-trailer vehicle and the lift at the time the container is lowered into place. In this process, the lift is at the height of the current loading position on the trailer platform. The determined distance between the lift and the tractor thus associates the position of the loaded containers to the position on a trailer behind the tractor.

Once several containers have been placed onto the trailer platforms (“loaded”), the sequence of the containers in the tractor-trailer vehicle can be determined.

Another improved embodiment of this process step can also determine whether one or more containers have been placed on the trailer platform in question. If the trailer platform is sized to handle two 20 ft or one 40 ft container, it can thus be determined whether the loading platform has room for an additional 20 ft container.

It is an additional advantage that the process is not limited to a single trailer. The process may be applied to any length of tractor-trailer vehicles with multiple trailers, as long as the distance between the crane and the tractor can be determined.

This is now the first method to determine an unambiguous loading relationship between the containers placed on the trailer platform and the tractor-trailer vehicle in question. Thus, a value has been found to specify the loaded position of each container on the respective vehicle.

This is specified as three data values consisting of the following data:

Container ID (A)+vehicle ID+distance (A)

or alternatively

Container ID (B)+vehicle ID+distance (B).

The triple values refer to an application where trailer platform A supports a single container. If the tractor-trailer vehicle is loaded with several containers, additional triple value sets will be used and evaluated. Letter B refers here to the rear trailer platform.

Once the process of the invention has made an unambiguous determination regarding the loading of trailers of a tractor-trailer vehicle with one or more containers, the vehicle is moved to a storage area, where a container crane located there unloads the loaded containers to a storage position.

Based on the values determined for each container during the loading process, the distance determination can be repeated during the unloading process and the container can be identified by a comparison of the values of all containers of the tractor-trailer vehicle in question.

It is thus important that the distance between the tractor and the lift is also determined for the unloading crane in order to make an unambiguous linkage between the various loaded platforms of the tractor-trailer vehicle and the lift of the unloading crane.

The result of the distance measurement is compared to the previously discussed triple data set from the dockside container crane. If the distances essentially correspond, it is thus known that this is container X on the tractor-trailer vehicle in the area of the lift of the unloading crane.

Consequently, the container currently on the lift is identified unambiguously.

A container can thus be tracked automatically, and the crane operator does not need to take action, who would otherwise need to take manual notes regarding which container was unloaded at what location.

A further advantageous embodiment assures the automatic tracking of the container. This is particularly important when the container is placed onto a tractor-trailer vehicle by a loading crane, where the tractor-trailer vehicle then moves the container to an unloading crane.

The identification of the container itself, i.e. the recognition of the unambiguous number of the container, is handled in accordance with the state of the art. For example, it may be handled manually or with OCR recognition.

It is important to the invention that there is automatic tracking of the containers unloaded in the harbor and their movement to a storage site, which is subject to significantly less error, because manual intervention is no longer required.

Of course, the process of the invention can operate in the reverse direction as well, namely when a container is loaded at a storage site by a crane onto the platform of a tractor-trailer vehicle, whence it is moved by said tractor-trailer vehicle including one or more platforms to a dockside crane for loading onto a ship. In addition, the process may also operate between two dockside cranes or two storage area cranes.

The determination of the distance between the tractor and the lift may be handled by various known direct or indirect processes, such as a Real-Time Location System (RTLS) or position determination by a satellite navigation system (GPS).

It is an advantage of the invention that merely the tractor of a tractor-trailer vehicle including several trailer platforms needs to be identified. The various loading platforms do not need to be described by a separate infrastructure.

It is an advantage of the invention that it does not require optical comparisons between a tractor-trailer vehicle standing beneath a loading crane and the lift.

The object of the invention derives not only from the objects of the separate patent claims, but also from a combination of the patent claims.

All statements and characteristics listed in the documentation, including the summary, specifically the spatial embodiment presented in the figures, are reserved as essential to the invention to the extent that they are novel by themselves or in combination relative to the state of the art.

The following describes the invention in more detail by reference to figures showing merely one embodiment example. The figures and their description identify other essential characteristics and advantages of the invention.

They show:

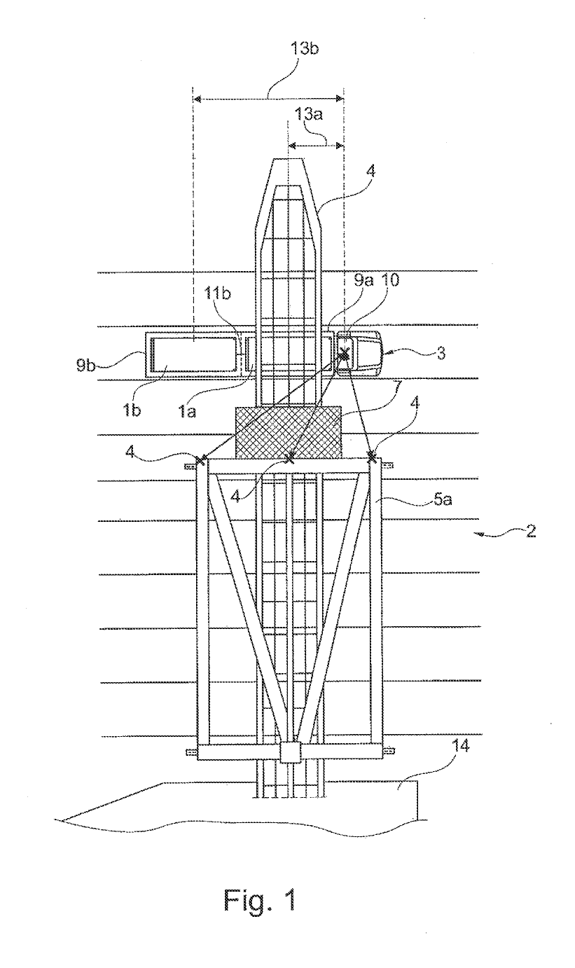

FIG. 1: A top view of a harbor terminal

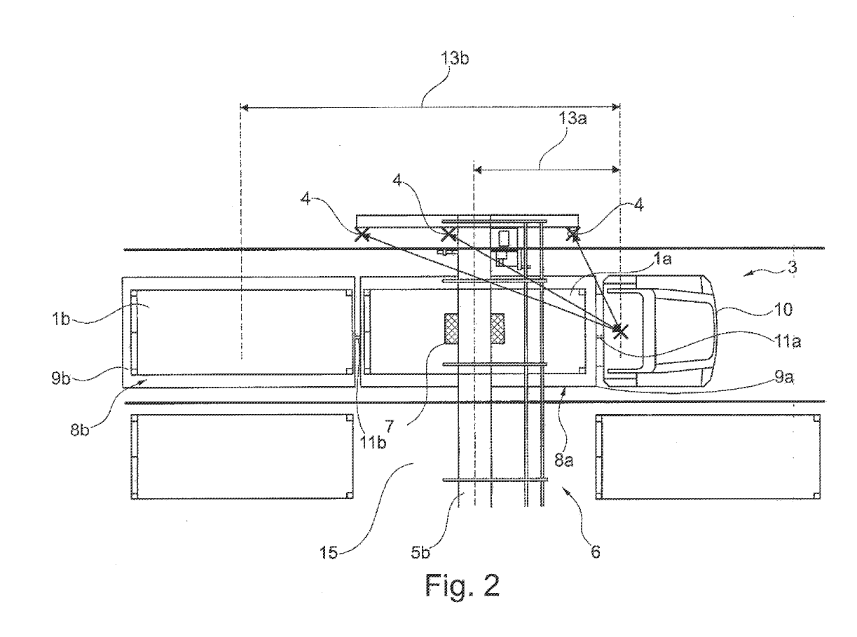

FIG. 2: Depiction of the measurement points on the lift and on the tractor

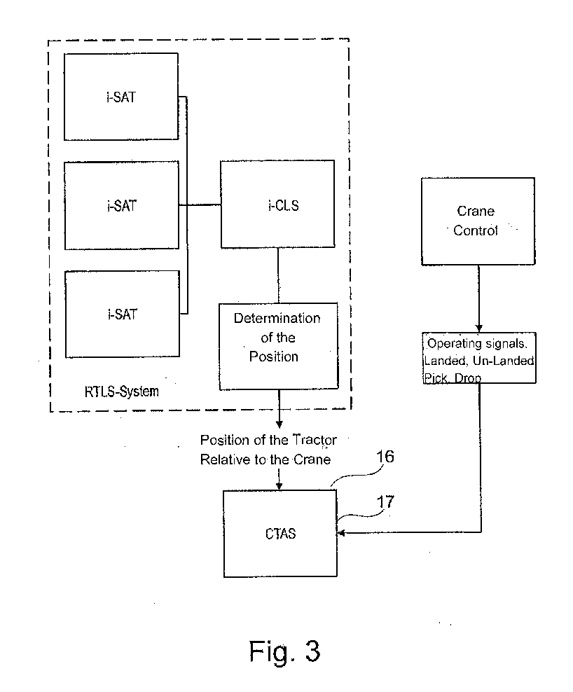

FIG. 3: A schematic of the linkage of an RTLS system with the crane control and a harbor-wide control system CTAS

FIG. 1 depicts harbor terminal 2 in a top view. Container 1 is neing moved between at least two means of transport.

Container 1 is raised by container crane 5a. It may be embodied as a container bridge, for example. Lift 7, which is controlled by a bridge operator, moves container 1 from a ship to harbor terminal 2. Container 1 is moved there to a vehicle (tractor-trailer vehicle) 3 to be transported by the same to placement position 6 or to another transport device. The transport of container 1 from container crane 5 to placement position 6 is handled by vehicle 3 with one or more attached trailers 8a, 8b.

The example shown here depicts the transfer of at least one container 1a, 1b from ship 14 to a vehicle or tractor-trailer vehicle. Vehicle 3 consists here of tractor 10 and at least one trailer 8a, 8b. Tractor 10 is embodied as a motorized propulsion vehicle, to which trailers 8a, 8b are attached sequentially.

The position of the loaded or unloaded container (1a, 1b) on one of trailers (8a, 8b, 9a, 9b) of vehicle (3) is determined by determining the distance (13, 13a, 13b) between vehicle (3) and container crane (5a, 5b).

Distance 13 is determined. In the depicted example by measuring the distance between tractor 10 and distance measurement points on the crane by means of an RTLS system. A triangulation measurement will result from using several separate distance measurement points 4.

The lift or container crane 5a, 5b will have at least as many distance measurement points 4 as are required to determine distance 13 to tractor 10.

Container 1 is lifted by lift 7, which supports container 1 at its center. This assures a fixed position of container 1a, 1b within lift 7. According to the invention, an unambiguous association of container 1a, 1b being loaded onto the respective trailer platforms 9a and 9b is thus assured. Even if trailer platforms 9 are loaded with several containers 1a, 1b, an unambiguous association is feasible.

FIG. 2 shows the offloading of a container from vehicle 3 to placement position 6. This uses container crane 5b.

It is important that the same distance measurement 13 is taken on container crane 5b as was taken on container crane 5a. Thus, there will be a measurement with subsequent determination of the distance between tractor 10 and the crane or lift 7.

The values of the second measurement will be compared against the distance data from loading container crane 5a for container 1a, 1b on the vehicle.

This yields an unambiguous association of loaded container 1a, 1b to the various loading platforms of vehicle 3. From the stored values from the first measurement, it is feasible to identify the desired container 1a, 1b on the vehicle and to select it for unloading.

Thus, in order to determine the position of the loaded or unloaded container 1a, 1b on one of trailers 8a, 8b, 9a, 9b of vehicle 3, the first value 16 obtained at loading the loaded container 1a, 1b onto one of trailers 8a, 8b, 9a, 9b of vehicle 3 will be compared against the second value 17 obtained at unloading in order to identify container 1a, 1b. if the two values 16, 17 are a close match.

A close match is defined to be a difference of the measured distances that does not exceed one-half of the length of a container, because the lift will always be centered in its working position on container 1a, 1b.

The schematic shown in FIG. 3 shows additional details of the invention.

The Real Time Location System (RTLS) determines the position of vehicle 3 relative to container crane 5a, 5b or lift 7. These data are fed into the harbor Container Terminal Automation System (CTAS). The crane control feeds the information regarding the operating signals, such as Container ID, Landed, Un-Landed, Pick and Drop, to the CTAS to be used to identify and locate a specific container 1a, 1b.

It is important that the distance measurement is not limited to the measurement of the distance between crane 5 and tractor 10. Other distance measurements are also feasible to determine the position of a container on the vehicle. For example, the distance between distance measurement point 4 on the container crane and a point in the rear of the first trailer or at the end of vehicle 3 may also be used.

Distance measurement points 4 on the crane may be located in the present invention either on the frame of crane 5 or on lift 7 or at any other point on the crane.

The particular value 16 to be determined for the container in question will be determined by CTAS. Value 16 results from the data described above.

It is an essential advantage of the invention that a measurement of the distance between the crane and the tractor of a vehicle with several components will suffice to determine the location of a container and to track said container during the offloading process.

### LEGEND

1 Container (a, b)
2 Harbor terminal
3 Vehicle
4 Distance measurement point
5 Container crane (5a, 5b)
6 Placement position
7 Lift
8a Forward trailer
8b Rear trailer
9a Forward trailer platform
9b Rear trailer platform
10 Tractor or propulsion machinery
11a Forward trailer hitch
11b Rear trailer hitch
12
13 Distance determination
13a Distance to the forward trailer 8a
13b Distance to the rear trailer 8b
14 Ship
15 Storage position
16 Value
17 Value

1. A process to track at least one container (1a, 1b), which is loaded at the unloading area of harbor terminal (2) by container crane (5a) located there onto at least one trailer (8a, 8b) of vehicle (3), which is moved to placement position (6), and which is unloaded there by a second container crane (5b) to storage position (15), characterized by having the position of the loaded or unloaded container (1a, 1b) on one of the trailers (8a, 8b, 9a, 9b) of vehicle (3) determined by a measurement of the distance (13, 13a, 13b) between vehicle (3) and container crane (5a, 5b).

2. The process of claim 1, characterized by having distance (13) measured indirectly by a measurement of the distance between vehicle (3) and distance measurement point (4).

3. The process of claim 1, characterized by having the distance measurement refer to the distance between tractor (10) of vehicle (3) and lift (7) of crane (5).

4. The process of claim 1, characterized by having a unique value (16) for the container (1) in question computed from the measured distance (13), the vehicle identification and the container identification.

5. The process of claim 4, characterized by having value (16), which includes distance (13a, 13b) and other data, identify storage position (15) of container (1) on one or more trailer platforms (9a, 9b) of vehicle (3).

6. The process of claim 1, characterized by having value (16), which includes the position of container (1a, 1b), used at storage position (6, 15) for the identification of container (1).

7. The process claim 1, characterized by using an WITS system, an ultrasound system or an optical distance measurement process to determine distance (13).

8. The process of claim 1, characterized by completing a second distance measurement (13) at the storage position (6, 15) of container (1a, 1b), which yields a value (17) including the identification of the container.

9. The process of claim 1, characterized by making a comparison of the first value (16) for container (1a, 1b) loaded onto one of trailers (8a, 8b, 9a, 9b) of vehicle (3) to the second value (17) formed during unloading in order to determine the position of the loaded or unloaded container (1a, 1b) on one of the trailers (8a, 8b, 9a, 9b) of vehicle (3), where container (1a, 1b) will be identified, if the two values (16, 17) are a close match.

10. The process of claim 1, characterized by having the determination of distance (13) take place during the loading and/or unloading process of container (1).

11. The process of claim 2, characterized by having the distance measurement refer to the distance between tractor of vehicle and lift of crane.

12. The process of claim 2, characterized by having a unique value for the container in question computed from the measured distance, the vehicle identification and the container identification.

13. The process of claim 3, characterized by having a unique value for the container in question computed from the measured distance, the vehicle identification and the container identification.

14. The process of claim 2, characterized by having value, which includes the position of container, used at storage position for the identification of container.

15. The process of claim 3, characterized by having value, which includes the position of container, used at storage position for the identification of container.

16. The process of claim 4, characterized by having value, which includes the position of container, used at storage position for the identification of container.

17. The process of claim 5, characterized by having value, which includes the position of container, used at storage position for the identification of container.

18. The process claim 2, characterized by using an RTLS system, an ultrasound system or an optical distance measurement process to determine distance.

19. The process claim 3, characterized by using an RTLS system, an ultrasound system or an optical distance measurement process to determine distance.

20. The process claim 4, characterized by using an RTLS system, an ultrasound system or an optical distance measurement process to determine distance.
